(19) United States
(12) Patent Application Publication
(10) Pub. No.: US 2017/0067379 A1
(43) Pub. Date: Mar. 9, 2017

(54) MUFFLER FOR AN EXHAUST SYSTEM OF AN INTERNAL COMBUSTION ENGINE

(71) Applicant: BOMBARDIER RECREATIONAL PRODUCTS INC., Valcourt (CA)

(72) Inventors: Claude DELORME, Waterloo (CA); Max RICHER, Valcourt (CA)

(21) Appl. No.: 15/121,232

(22) PCT Filed: Feb. 25, 2015
(86) PCT No.: PCT/IB2015/051405

§ 371 Date: Aug. 24, 2016

Related U.S. Application Data
(60) Provisional application No. 61/944,236, filed on Feb. 25, 2014.

(51) Int. Cl. F01N 1/08; B62M 27/02; F01N 1/24

(52) U.S. Cl. CPC F01N 1/083; F01N 1/24; B62M 27/02; B62M 2027/023

(57) ABSTRACT

A muffler for an exhaust system of an internal combustion engine having a muffler body, a first chamber defined in the muffler body, a second chamber disposed at least in part in the first chamber, and a third chamber disposed at least in part in the first chamber. The second chamber has an inlet, an outlet, and at least one side wall. The at least one side wall of the second chamber defines at least one aperture fluidly communicating with the first chamber. The third chamber has an inlet, an outlet, and at least one side wall. The at least one side wall of the third chamber defines at least one aperture fluidly communicating with the first chamber. The outlet of one of the second and third chambers fluidly communicates with the first chamber. A vehicle having the muffler is also disclosed.

### CROSS-REFERENCE

The present application claims priority to U.S. Provisional Patent Application No. 61/944,236, filed Feb. 25, 2014, the entirety of which is incorporated herein by reference.

### FIELD OF TECHNOLOGY

The present technology relates to mufflers for exhaust systems of internal combustion engines, and vehicles having an exhaust system with a muffler.

### BACKGROUND

Vehicles having an internal combustion engine are provided with exhaust systems to deliver the exhaust gases generated by the engine from the engine to the atmosphere. In order to reduce the noise emitted by the exhaust of the engine, many exhaust systems are provided with one or more mufflers.

Mufflers create a path for the sound pressure exiting the engine through its exhaust port to travel. This path is designed to reduce the loudness of the sound pressure through various acoustic quieting techniques. The exhaust gases exiting the engine have to travel the same path as the sound pressure. As the path formed by the muffler tends to be tortuous in order to reduce the noise level, one of the downsides of mufflers is that they increase back pressure which reduces engine efficiency.

Therefore in designing a muffler, a trade-off often has to be made between noise reduction and reduction in engine efficiency due to back pressure.

Another challenge in designing an exhaust system and a muffler lies in the amount of room available in the vehicle. As the amount of room is limited, especially in straddle-type vehicles such as snowmobiles, the muffler has to be as compact as possible while providing an acceptable level of noise reduction.

### SUMMARY

In one aspect, implementations of the present technology provide a muffler for an exhaust system of an internal combustion engine having a muffler body, a first chamber defined in the muffler body, a second chamber disposed at least in part in the first chamber, and a third chamber disposed at least in part in the first chamber. The second chamber has an inlet, an outlet, and at least one side wall. The at least one side wall of the second chamber defines at least one aperture fluidly communicating with the first chamber. The third chamber has an inlet, an outlet, and at least one side wall. The at least one side wall of the third chamber defines at least one aperture fluidly communicating with the first chamber. The outlet of one of the second and third chambers fluidly communicates with the first chamber.

In some implementations of the present technology, the first chamber surrounds the second and third chambers.

In some implementations of the present technology, a fourth chamber is adjacent the first chamber. The outlet of the one of the second and third chambers fluidly communicates with the first chamber via the fourth chamber.

In some implementations of the present technology, a plate separates the first chamber from the fourth chamber. The plate defines at least one aperture fluidly communicating the fourth chamber with the first chamber.

In some implementations of the present technology, at least one mesh surrounds the at least one side wall of at least one of the second and third chambers, and sound absorbing material is disposed between the at least one side wall of the at least one of the second and third chambers and a corresponding one of the at least one mesh.

In some implementations of the present technology, the sound absorbing material is a first sound absorbing material, and a second sound absorbing material is disposed in the first chamber.

In some implementations of the present technology, sound absorbing material is disposed in the first chamber.

In some implementations of the present technology, a fourth chamber is disposed at least in part in the first chamber. The fourth chamber has an inlet, an outlet, and at least one side wall. The at least one side wall defines at least one aperture. The at least one aperture fluidly communicates with the first chamber.

In some implementations of the present technology, the second chamber is defined by a first pipe, the third chamber is defined by a second pipe, the first chamber is defined at least in part by a plate and the muffler body, and the first and second pipes extend through the plate.

In another aspect, implementations of the present technology provide a muffler having a muffler body, a first plate disposed in the muffler body, a second plate disposed in the muffler body, a first chamber defined between the muffler body and the first plate, a second chamber defined between the first plate, the second plate and the muffler body, a third chamber defined between the muffler body and the second plate, the second chamber being disposed between the first and third chambers, a first pipe having an inlet disposed outside the muffler body and an outlet communicating with the first chamber, the first pipe extending through the muffler body and the first plate, the first pipe having at least a portion disposed in the second chamber, a second pipe having an inlet communicating with the first chamber and an outlet communicating with the third chamber, the second pipe extending through the first plate, the second chamber and the second plate, and a third pipe having an inlet communicating with the third chamber and an outlet disposed outside the muffler body, the third pipe extending through the second plate and the muffler body, the third pipe having at least a portion disposed in the second chamber. At least two of the first pipe, the second pipe and the third pipe defining at least one aperture disposed in and fluidly communicating with the second chamber.

In some implementations of the present technology, the first pipe extends through the muffler body, the second plate, the second chamber and the first plate, and the third pipe extends through the second plate, the second chamber, the first plate and the muffler body.

In some implementations of the present technology, each of the first pipe, the second pipe and the third pipe defines at least one aperture disposed in and fluidly communicating with the second chamber.

In some implementations of the present technology, a first mesh is disposed in the second chamber around the first pipe, a second mesh is disposed in the second chamber around the second pipe, a first sound absorbing material is disposed between the first mesh and the first pipe, a second sound absorbing material is disposed between the second mesh and the second pipe, and a third sound absorbing material is disposed in the second chamber around the third pipe.

In some implementations of the present technology, at least one aperture is defined in one of: the first plate for fluidly communicating the first chamber with the second chamber, and the second plate for fluidly communicating the third chamber with the second chamber.

In another aspect, implementations of the present technology provide a vehicle having an internal combustion engine having at least one exhaust port and a muffler fluidly communicating with the at least one exhaust port. The muffler has a muffler body, a first chamber defined in the muffler body and fluidly communicating with the at least one exhaust port, a second chamber disposed at least in part in the first chamber, and a third chamber disposed at least in part in the first chamber. The second chamber has an inlet, an outlet, and at least one side wall. The at least one side wall of the second chamber defines at least one aperture fluidly communicating with the first chamber. The third chamber has an inlet, an outlet, and at least one side wall. The at least one side wall of the third chamber defines at least one aperture fluidly communicating with the first chamber. The outlet of one of the second and third chambers fluidly communicates with the first chamber.

In some implementations of the present technology, the muffler also has a fourth chamber adjacent the first chamber, and a plate separating the first chamber from the fourth chamber. The plate defines at least one aperture fluidly communicating the fourth chamber with the first chamber. The outlet of the one of the second and third chambers fluidly communicates with the first chamber via the fourth chamber and the at least one aperture defined in the plate.

In some implementations of the present technology, the muffler also has at least one mesh surrounding the at least one side wall of at least one of the second and third chambers and sound absorbing material disposed between the at least one side wall of the at least one of the second and third chambers and a corresponding one of the at least one mesh.

In some implementations of the present technology, the muffler also has sound absorbing material disposed in the first chamber.

In some implementations of the present technology, the second chamber is defined by a first pipe, the third chamber is defined by a second pipe, the first chamber is defined at least in part by a plate and the muffler body, and the first and second pipes extend through the plate.

In some implementations of the present technology, a frame supports the engine. The frame includes a tunnel. At least one ski is operatively connected to the frame. A drive track is driven by the engine and is disposed in part inside the tunnel.

For purposes of this application, terms related to spatial orientation such as forwardly, rearwardly, upwardly, downwardly, left, and right, are as they would normally be understood by a driver of the vehicle sitting thereon in a normal riding position.

Implementations of the present technology each have at least one of the above-mentioned aspects, but do not necessarily have all of them.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a snowmobile;

FIG. 2 is a perspective view taken from a front, right side of the snowmobile of FIG. 1 with the endless drive track and fairings removed;

FIG. 3 is a top plan view of a muffler of the snowmobile of FIG. 1;

FIG. 4 is a right side elevation view of the muffler of FIG. 3;

FIG. 5 is a perspective view taken from a rear, right side of the muffler of FIG. 3 with a right cover of a muffler body removed;

FIG. 6 is a perspective view taken from a rear, right side of the muffler of FIG. 3 with the right cover of the muffler body and sound absorbing material removed;

FIG. 7 is a perspective view taken from a front, left side of the muffler of FIG. 3 with a left cover of the muffler body removed;

FIG. 8 is cross-sectional view of the muffler of FIG. 3 taken through line 8-8 of FIG. 3; and

FIG. 9 is cross-sectional view of the muffler of FIG. 3 taken through line 9-9 of FIG. 4.

### DETAILED DESCRIPTION

The present technology will be described with respect to a snowmobile. However it is contemplated that at least some aspects of the present technology could be provided on vehicles other than snowmobiles, such as, but not limited to, an all-terrain vehicle (ATV) or a side-by-side off-road vehicle (SSV).

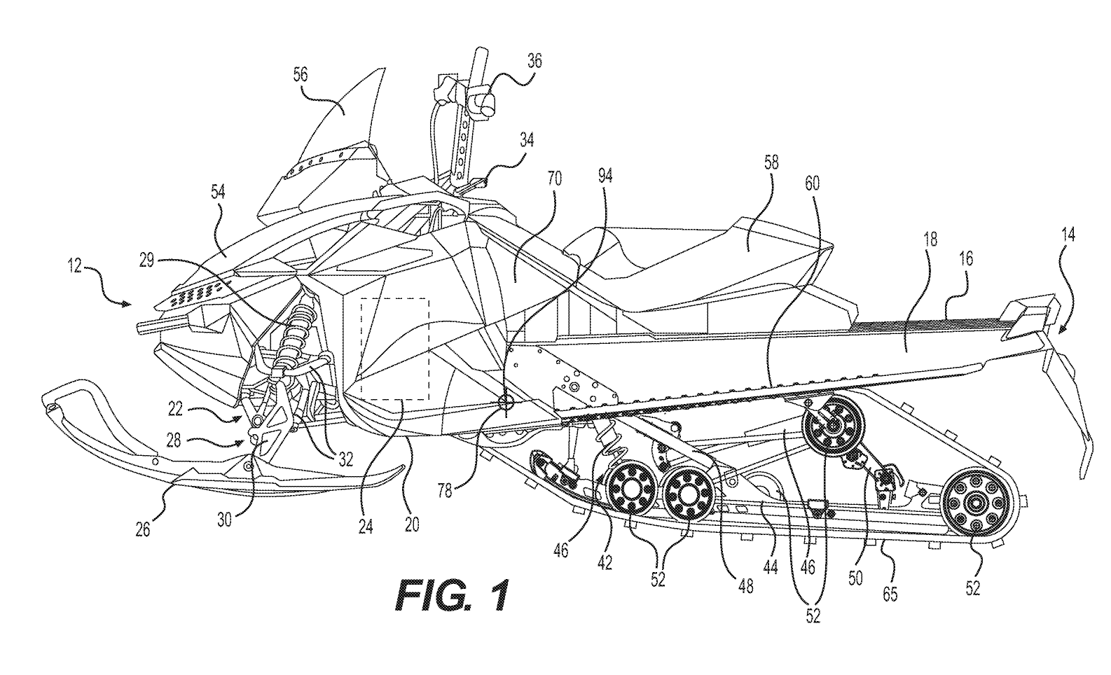

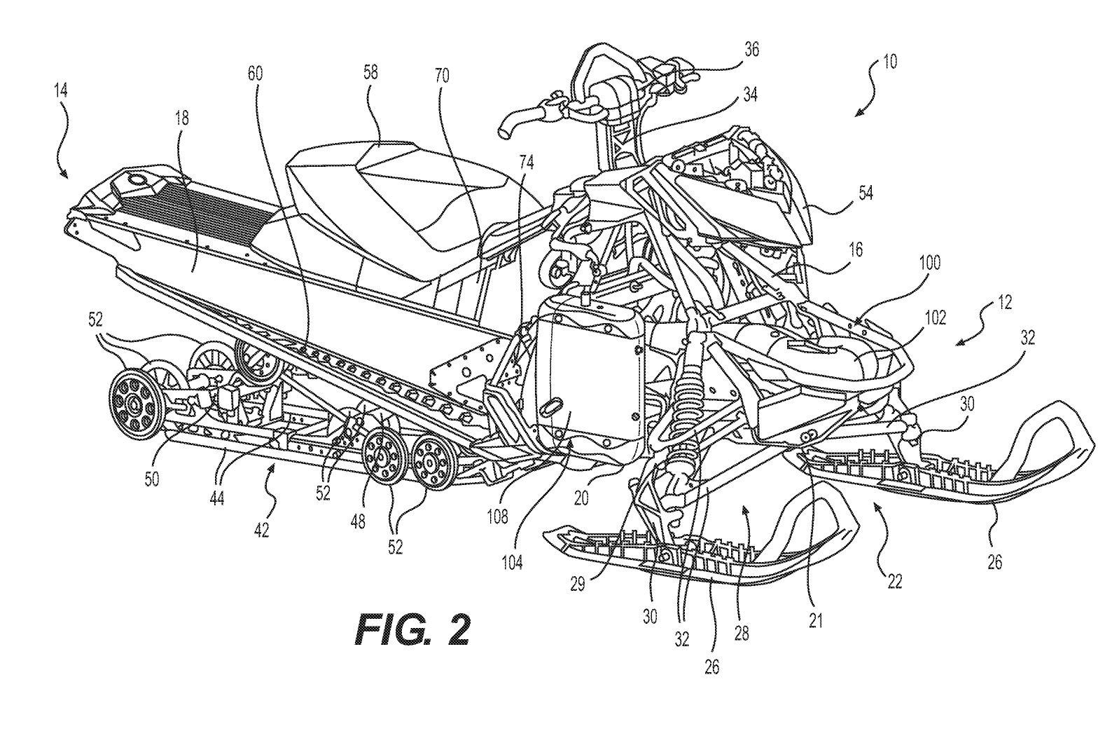

As can be seen in FIG. 1, a snowmobile 10 includes a forward end 12 and a rearward end 14 that are defined consistently with a travel direction of the snowmobile 10. The snowmobile 10 includes a frame 16 that includes a tunnel 18, an engine cradle 20 and a suspension module 21 (FIG. 2). A front suspension 22 is connected to the suspension module 21. The tunnel 18 generally consists of pieces of sheet metal bent to form an inverted U-shape. The tunnel 18 extends rearwardly along the longitudinal centerline of the snowmobile 10 and is connected at the front to the engine cradle 20. An engine 24, which is schematically illustrated in FIG. 1, is mounted to the engine cradle 20. Two skis 26 are positioned at the forward end 12 of the snowmobile 10 and are attached to the front suspension 22. The front suspension 22 includes a pair of front suspension assemblies 28. Each front suspension assembly 28 includes a ski leg 30, a pair of A-arms 32 and a shock absorber 29 for operatively connecting the corresponding ski 26 to a steering column 34. Other types of front suspension assemblies 28 are contemplated, such as a swing-arm or a telescopic suspension. It is also contemplated that the snowmobile 10 could have only one ski 26. A steering device in the form of a handlebar 36, positioned forward of a rider, is attached to the upper end of the steering column 34 to allow the rider to rotate the ski legs 30 and thus the skis 26, in order to steer the snowmobile 10. U.S. Pat. No. 8,037,961, issued Oct. 18, 2011, the entirety of which is incorporated herein by reference, provides additional details regarding a steering assembly and front suspension assemblies suitable for the snowmobile 10.

An endless drive track 65 is positioned at the rear end 14 of the snowmobile 10. The endless drive track 65 is disposed generally under the tunnel 18, and is operatively connected to the engine 24 as will be described in greater detail below. The endless drive track 65 is driven to run about a rear suspension assembly 42 for propelling the snowmobile 10. The rear suspension assembly 42 includes a pair of slide rails 44 in sliding contact with the endless drive track 65. The rear suspension assembly 42 also includes two shock absorbers 46, one of which includes a coil spring surrounding the individual shock absorbers 46. Suspension arms 48 and 50 are provided to attach the slide rails 44 to the frame 16. Multiple idler wheels 52 are also provided in the rear suspension assembly 42.

At the front end 12 of the snowmobile 10, fairings 54 enclose the engine 24, thereby providing an external shell protecting the engine 24 and its associated components. The engine cradle 20 and the fairings 54 therefore define an engine compartment. The fairings 54 include a hood and side panels that can be opened to allow access to the engine 24 when this is required, for example, for inspection or maintenance of the engine 24. In the particular snowmobile 10 shown in FIG. 1, the side panels can be opened along a vertical axis to swing away from the snowmobile 10. A windshield 56 is connected to the fairings 54 near the front end 12 of the snowmobile 10 or alternatively directly to the handlebar 36. The windshield 56 acts as a windscreen to lessen the force of the air on the rider while the snowmobile 10 is moving.

A straddle-type seat 58 is positioned atop the frame 16 and more specifically on the fuel tank 70. The fuel tank 70 is connected to the top of the tunnel 18 at a front thereof. Two footrests 60 are positioned on opposite sides of the snowmobile 10 below the seat 58 to accommodate the driver's feet.

A power pack for powering the endless drive track 65 will now be described. The power pack includes, but is not limited to, the engine 24, a variable ratio belt transmission system, also known as a continuously variable transmission or CVT (not shown), a reduction gearing 74 (FIG. 2), a countershaft (not shown) and a drive axle 78.

The engine 24 is a two-cylinder, two-cycle internal combustion engine. It is contemplated that the engine 24 could be of any other type, such as a four-cycle internal combustion engine. The engine 24 is disposed transversely in the engine cradle 20 and rests on vibration dampers (not shown) to reduce the transmission of vibrations from the engine 24 to the frame 16. The vibration dampers are rubber mounts. The engine 24 comprises a crankshaft (not shown) that is integrally formed with an output shaft (not shown). The crankshaft and output shaft rotate about a horizontally disposed output shaft axis that extends generally transversely to a longitudinal centerline of the snowmobile 10. It is contemplated that the crankshaft and output shaft could be separate shafts disposed coaxially such that the crankshaft drives the output shaft. It is also contemplated that the crankshaft and output shaft could be separate shafts that are offset from one another and could also rotate at different speeds relative to one another.

The CVT is disposed on a left side of the engine 24 and includes a driving pulley coupled to rotate with the output shaft of the engine 24 and a driven pulley coupled to the left end of the transversely mounted countershaft to rotate with the countershaft. A drive belt disposed around the pulleys transmits power from the driving pulley to the driven pulley. The driving pulley includes a pair of opposed frustoconical belt drive sheaves (one fixed sheave and one moving sheave) between which the drive belt is located. The sheaves are biased apart, and the driving pulley incorporates a centrifugally operated mechanism that acts to urge the moving sheave towards the fixed sheave with a force that increases with increasing output shaft speed so that as the engine speed increases, the reduction ratio of the CVT decreases. The driven pulley includes a pair of frustoconical belt drive sheaves between which the drive belt is located. The driven pulley reacts to the torque from the endless drive track 65 by separation of its sheaves which allows the drive belt to engage the driven pulley at a diameter that is progressively reduced as the torque increases or that is progressively increased as the torque decreases. When the driving pulley increases its effective diameter, the driven pulley decreases its effective diameter and vice versa, thus keeping the drive belt in tension. The drive belt is made of rubber, but it is contemplated that it could be made of metal.

The countershaft traverses the width of the engine cradle 20, is disposed rearward of the engine 24 and defines a countershaft axis. The reduction gearing 74 is disposed on a right side of the engine 24. The right end of the countershaft is connected to an input member of the reduction gearing 74. The input member of the reduction gearing 74 consists of a small sprocket (not shown) connected to the countershaft. An output member of the reduction gearing is connected to the drive axle 78. The output member consists of a sprocket (not shown) that is larger than the sprocket of the input member and is connected to the drive axle 78. The output member is driven via a chain (not shown) by the input member. It is also contemplated that the output member could be driven via gears by the input member. The input member, the output member, and the chain are enclosed within the housing of the reduction gearing 74. The drive axle 78 is disposed in the tunnel 18 and carries sprocket wheels (not shown) that form a driving connection with the endless drive track 65. The drive axle 78 defines a drive axle axis 94.

It is contemplated that the reduction gear 74 could be disposed on the left side of the engine 24 and that the CVT could be disposed on the right side of the engine 24.

The driving pulley rotates at the same speed as the output shaft. The speed of rotation of the countershaft is determined in accordance with the instantaneous ratio of the CVT. The drive axle 78 rotates at a lower speed than the countershaft since the reduction gearing 74 has a reduction ratio.

The engine 24 has two air intake ports (one per cylinder) on a rear side thereof that fluidly communicate with the cylinders of the engine 24. An air intake system (not shown) is connected to the air intake ports to supply air to the engine 24. The air intake system includes an air intake manifold (not shown), an air intake controller (not shown) and an air box (not shown). The air intake manifold is connected to the rear side of the engine 24 so as to fluidly communicate with the air intake ports. The air intake controller is connected to the top of the air intake manifold. It is contemplated that two intake controllers could be used. The air intake controller includes a valve that controls the flow of air to the engine 24. It is contemplated that the air intake controller could be in the form of a carburetor or a throttle body. The air box is connected to the top of the air intake controller. The air box defines the inlet of the air intake system. The inlet of the air intake system faces toward a left of the snowmobile 10. The air box has an air filter disposed inside of it.

The engine 24 has two exhaust ports (one per cylinder) disposed on a front side of the engine 24 that fluidly communicate with the cylinders of the engine 24.

An exhaust system 100 fluidly communicates with the engine 24 to exhaust the gases from the combustion process. The exhaust system 100 will now be described in more detail with reference to FIG. 2. The exhaust system 100 has an exhaust manifold (not shown) connected to the front of the engine 24 to fluidly communicate with the two exhaust ports. An outlet of the exhaust manifold is connected to an inlet of a tuned pipe 102. The tuned pipe 102 has a diverging portion connected to a generally U-shaped diverging portion that is connected to a converging portion defining an outlet of the tuned pipe 102.

The outlet of the tuned pipe 102 is connected to a muffler 104 disposed on a right side of the frame 16. More specifically, the outlet of the tuned pipe 102 is connected to an inlet pipe 106 of the muffler 104. It is contemplated that the muffler 104 could be disposed on the right side of the frame 16 or at any other suitable location on the snowmobile 10. Exhaust gases from the engine 24 flow through the exhaust manifold, into the tuned pipe 102, then into the muffler 104 via the inlet pipe 106, through a muffler body 108 of the muffler 104 as will be described below. From the muffler body 108, exhaust gases then flow to the atmosphere via an exhaust pipe 110 of the muffler 104. The exhaust pipe 110 extends through the engine cradle 20.

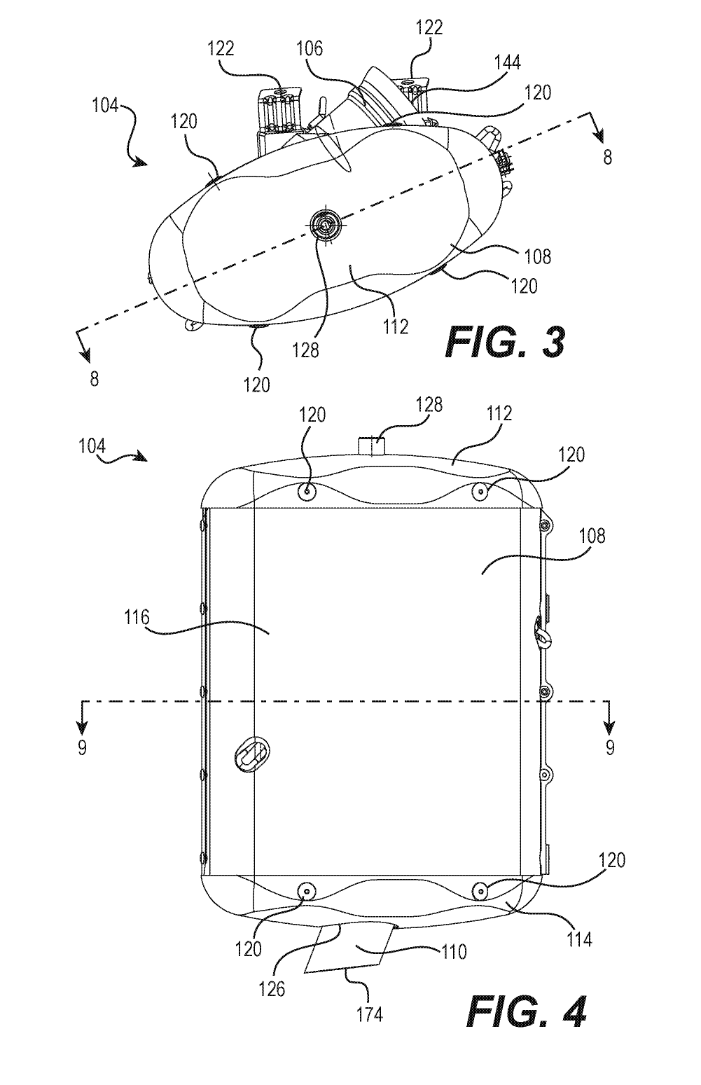

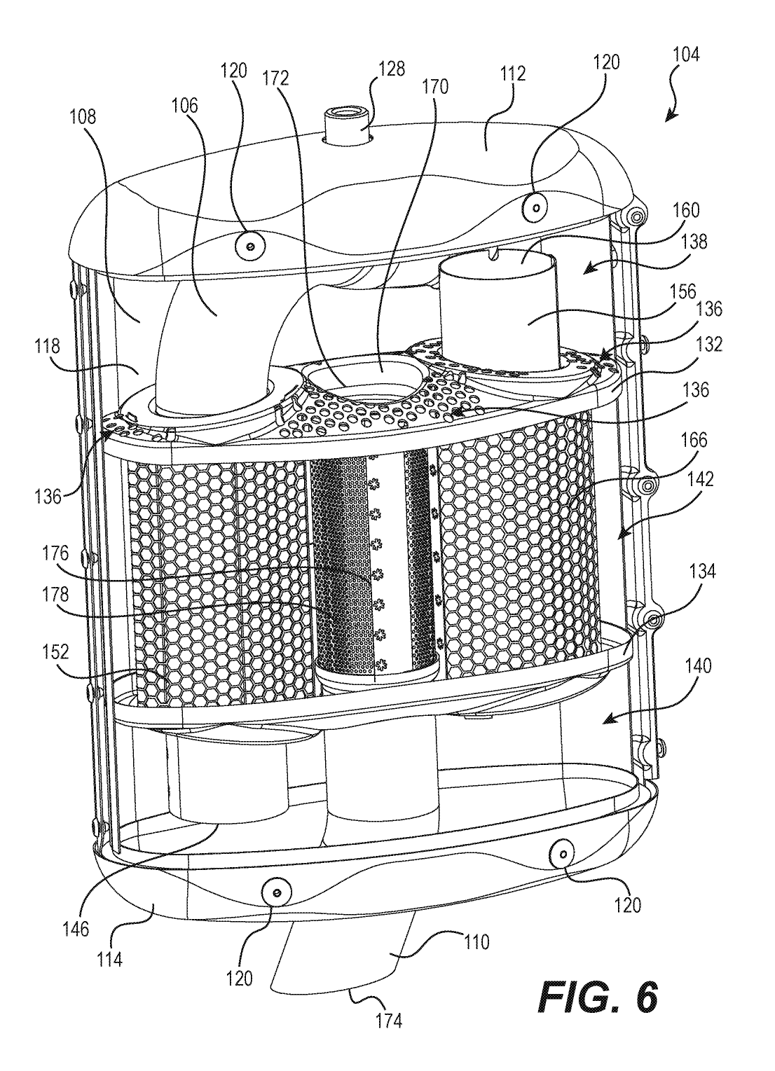

Turning now to FIGS. 3 to 9, the muffler 104 will be described in more detail. As described above, the muffler 104 has an inlet pipe 106, a muffler body 108 and an exhaust pipe 110.

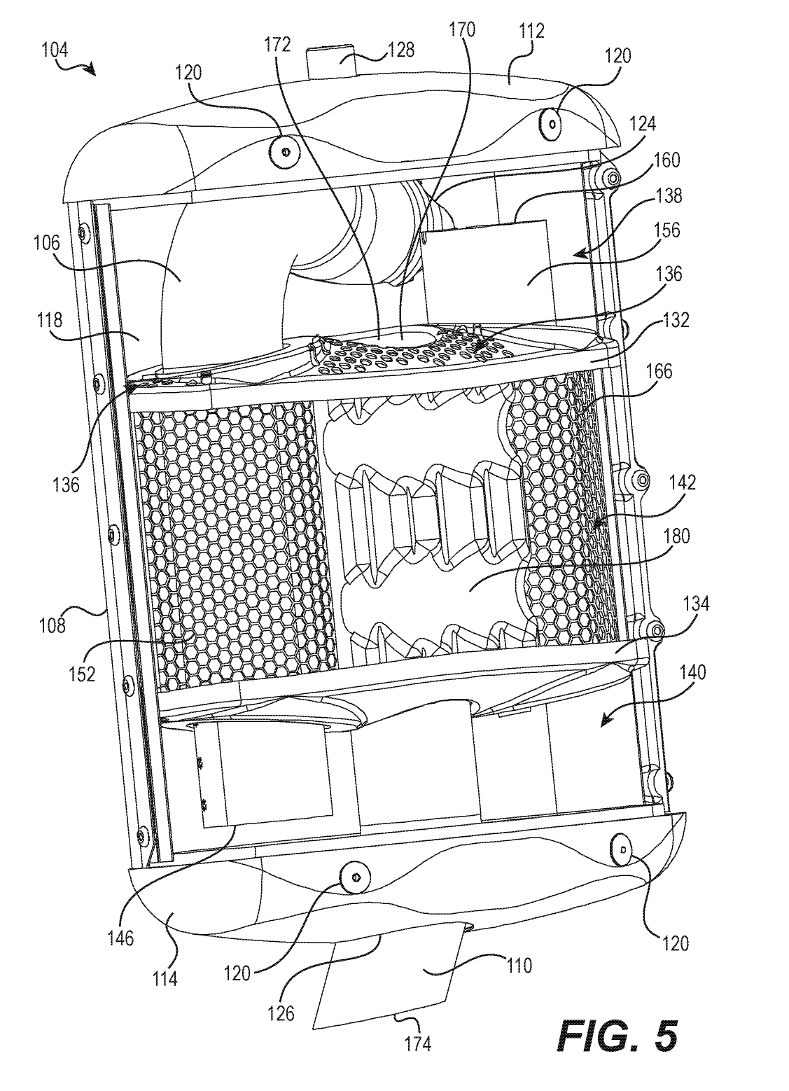

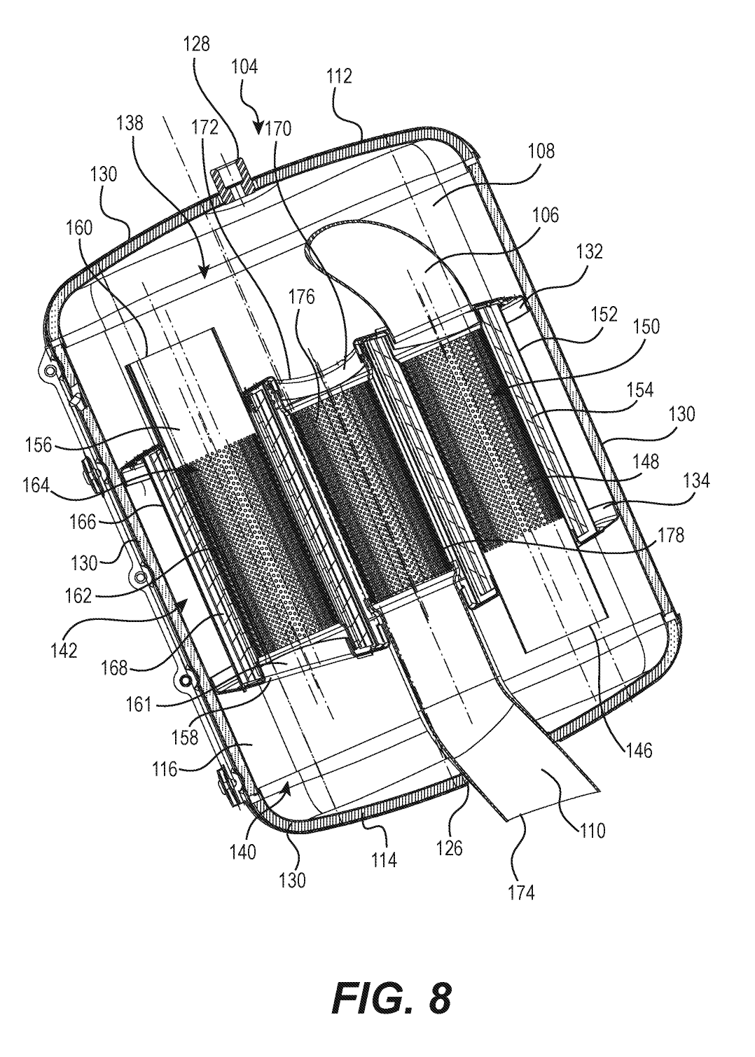

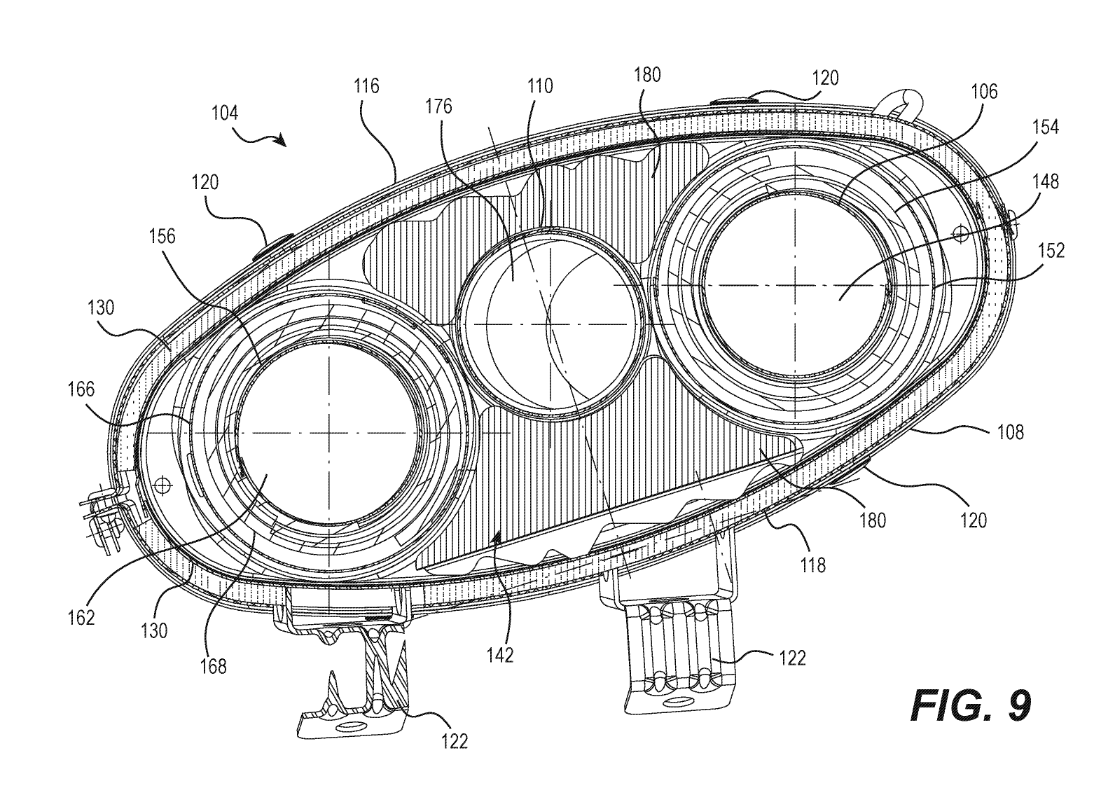

The muffler body 108 is made of a top cap 112, a bottom cap 114, a right cover 116 and a left cover 118 that are fastened to each other. The top cap 112 and the bottom cap 114 each have four fasteners 120 used to attach the top cap 112 and the bottom cap 114 to the right cover 116 and the left cover 118. In the present implementation, the fasteners 120 are rivets, but it is contemplated that other types of fasteners could be used. The left cover 118 has two brackets 122 used to fasten the muffler 104 to the frame 16 of the snowmobile 10. The left cover 118 defines an aperture 124 (FIG. 5) near a top thereof. The inlet pipe 106 is received in the aperture 124. The bottom cap 114 defines an aperture 126 in which the exhaust pipe 110 is received. A fitting 128 is received in the top cap 112. The fitting 128 receives an exhaust gas temperature sensor (not shown) therein. As best seen in FIGS. 8 and 9, the top cap 112, the bottom cap 114, the right cover 116 and the left cover 118 are each double-walled and have insulating material 130 disposed between the two walls.

As best seen in FIGS. 5 to 9, an interior of the muffler body 108 is separated into different chambers by upper and lower generally horizontally extending plates 132, 134. The upper plate 132 defines a number of small apertures 136. The lower plate 134 is free of small apertures, but it is contemplated that it could define such apertures. It is also contemplated that the upper plate could be free of small apertures and that the lower plate 134 could define small apertures 136. A top chamber 138 is defined above the upper plate 130. A bottom chamber 140 is defined below the lower plate 132. A central chamber 142 is defined between the upper and lower plates 132, 134. The small apertures 136 in the upper plate 132 fluidly communicate the upper chamber 138 with the central chamber 142. It is contemplated that one of the plates 132, 134 could be omitted.

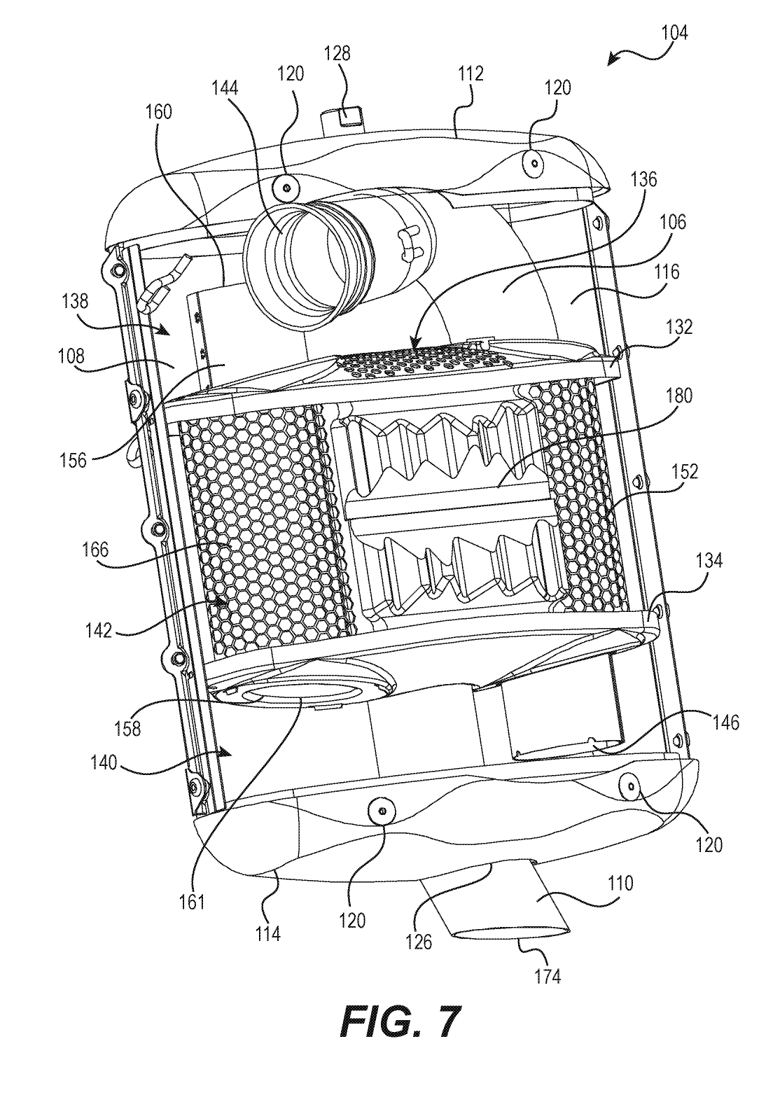

As can be seen in FIGS. 3 and 7, the inlet pipe 106 has an inlet 144 disposed outside of the muffler body 108. From its inlet 144, the inlet pipe 106 extends rearward through the aperture 124 in the left cover 118 of the muffler body 108 and into the top chamber 138. As can be seen in FIG. 5, the inlet pipe 106 then bends and extends downwardly through the upper plate 132, the central chamber 142 and the lower plate 134. As a result, an outlet 146 of the inlet pipe 106 is disposed in the lower chamber 140 near a rear thereof. As best seen in FIGS. 8 and 9, the inlet pipe 106 defines a chamber 148 between the upper and lower plates 132, 134. The side wall of the portion of the inlet pipe 106 defining the chamber 148 defines a plurality of small apertures 150. The apertures 150 fluidly communicate the chamber 148 with the central chamber 142. A mesh cylinder 152 is disposed around the chamber 148 between the upper and lower plates 132, 134. Sound absorbing material 154 is disposed between the mesh cylinder 152 and the side wall of the portion of the inlet pipe 106 defining the chamber 148. The sound absorbing material 154 has a mat-like structure, such as Hakotherm™ from HKO, but it is contemplated that other types of sound absorbing material could be used. It is contemplated that the mesh cylinder 152 and the sound absorbing material 154 could be omitted.

A pipe 156 having an inlet 158 extends from the lower chamber 140, through the lower plate 134, the central chamber 142 and the upper plate 132 to an outlet 160 disposed in the top chamber 138. Accordingly, the pipe 156 fluidly communicates the lower chamber 140 with the upper chamber 138. The inlet 158 of the pipe 156 is defined by a flange 161 formed by the lower plate 134. As best seen in FIGS. 8 and 9, the pipe 156 defines a chamber 162 between the upper and lower plates 132, 134. The side wall of the portion of the pipe 156 defining the chamber 162 defines a plurality of small apertures 164. The apertures 164 fluidly communicate the chamber 162 with the central chamber 142. A mesh cylinder 166 is disposed around the chamber 162 between the upper and lower plates 132, 134. Sound absorbing material 168 is disposed between the mesh cylinder 166 and the side wall of the portion of the pipe 156 defining the chamber 162. The sound absorbing material 168 has a mat-like structure, such as Hakotherm™ from HKO, but it is contemplated that other types of sound absorbing material could be used. It is contemplated that the mesh cylinder 166 and the sound absorbing material 168 could be omitted.

As can be seen in FIG. 8, a flange 170 of the upper plate 132 defines an inlet 172 of the exhaust pipe 110. The exhaust pipe 110 extends through the central chamber 142, the lower plate 134, the lower chamber 140, and the lower cap 114 via the aperture 126 to an outlet 174. As a result, the exhaust pipe 110 fluidly communicates the upper chamber 138 with the atmosphere. The exhaust pipe 110 defines a chamber 176 between the upper and lower plates 132, 134. The side wall of the portion of the pipe 110 defining the chamber 176 defines a plurality of small apertures 178. The apertures 178 fluidly communicate the chamber 176 with the central chamber 142. It is contemplated that a mesh cylinder could be disposed around the chamber 176 with sound absorbing material disposed between the mesh cylinder and the side wall of the portion of the pipe 110 defining the chamber 176. As can be seen, the chamber 176 is disposed between the chambers 148 and 162.

As can be seen each of the pipes 106, 110 and 156 is made of multiple sections. It is contemplated that each one of the pipes 106, 110 and 156 could be made of a single section or more or less sections than illustrated.

The volume of the central chamber 142 around the mesh cylinders 152, 166 and the exhaust pipe 110 is filled with sound absorbing material 180. It is contemplated that the volume of the central chamber 142 around the mesh cylinders 152, 166 and the exhaust pipe 110 could be only partially filled with sound absorbing material 180 or be free of sound absorbing material 180. In the present implementation, the sound absorbing material 180 is a loose fiber material such as Advantech™ from Silentec Limited, but it is contemplated that other types of sound absorbing material could be used. The sound absorbing material 180 has a lower density than the sound absorbing materials 154, 168.

From the tuned pipe 102, exhaust gases flow through the inlet pipe 106 into the lower chamber 140. Some of the exhaust gases and the sound pressure will also flow from the chamber 148, through the apertures 150, the sound absorbing material 154, and the mesh cylinder 152 into the central chamber 142. By passing through the sound absorbing material 154, the sound pressure is reduced. From the lower chamber 140, exhaust gases flow through the pipe 156 into the upper chamber 138. Some of the exhaust gases and the sound pressure will also flow from the chamber 162, through the apertures 164, the sound absorbing material 168, and the mesh cylinder 166 into the central chamber 142. By passing through the sound absorbing material 168, the sound pressure is reduced. From the upper chamber 138, exhaust gases flow through the exhaust pipe 110 to the atmosphere. From the upper chamber 138, some of the exhaust gases and the sound pressure will also flow through the apertures 136 in the plate 132 into the central chamber 142. Some of the exhaust gases and the sound pressure will also flow from the chamber 170, through the apertures 178 into the central chamber 142. The exhaust gases and the sound pressure present in the central chamber 142 flow through the sound absorbing material 180. By passing through the sound absorbing material 180, the sound pressure is reduced.

From the central chamber 142, the exhaust gases and the sound pressure flow back into the chambers 138, 148, 162 and 170 through their corresponding apertures, and where applicable, their corresponding mesh cylinder and sound absorbing material.

It is contemplated that the plates 132, 134, and the pipes 106, 110, 156 could be arranged differently than illustrated. It is contemplated that more plates and pipes could be provided. It is also contemplated that the muffler body 108 could be shaped differently than illustrated. For example, it is contemplated that the muffler body 108 could be generally cylindrical with a first closed end through which the inlet pipe 106 enters the muffler body 108 and a second closed end through which the exhaust pipe 110 extends out of the muffler body 108.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A muffler for an exhaust system of an internal combustion engine comprising:
a muffler body;
a first chamber defined in the muffler body;
a second chamber disposed at least in part in the first chamber, the second chamber having an inlet, an outlet, and at least one side wall, the at least one side wall defining at least one aperture, the at least one aperture fluidly communicating with the first chamber; and
a third chamber disposed at least in part in the first chamber, the third chamber having an inlet, an outlet, and at least one side wall, the at least one side wall defining at least one aperture, the at least one aperture fluidly communicating with the first chamber,
the outlet of one of the second and third chambers fluidly communicating with the first chamber.

2. The muffler of claim 1, wherein the first chamber surrounds the second and third chambers.

3. The muffler of claim 1, further comprising a fourth chamber adjacent the first chamber; and
wherein the outlet of the one of the second and third chambers fluidly communicates with the first chamber via the fourth chamber.

4. The muffler of claim 3, further comprising a plate separating the first chamber from the fourth chamber, the plate defining at least one aperture fluidly communicating the fourth chamber with the first chamber.

5. The muffler further of claim 1, further comprising:
at least one mesh surrounding the at least one side wall of at least one of the second and third chambers; and
sound absorbing material disposed between the at least one side wall of the at least one of the second and third chambers and a corresponding one of the at least one mesh.

6. The muffler of claim 5, wherein the sound absorbing material is a first sound absorbing material; and
further comprising a second sound absorbing material disposed in the first chamber.

7. The muffler of claim 1, further comprising sound absorbing material disposed in the first chamber.

8. The muffler of claim 1, further comprising a fourth chamber disposed at least in part in the first chamber, the fourth chamber having an inlet, an outlet, and at least one side wall, the at least one side wall defining at least one aperture, the at least one aperture fluidly communicating with the first chamber.

9. The muffler of claim 1, wherein:
the second chamber is defined by a first pipe;
the third chamber is defined by a second pipe;
the first chamber is defined at least in part by a plate and the muffler body; and
the first and second pipes extend through the plate.

10. A muffler comprising:
a muffler body;
a first plate disposed in the muffler body;
a second plate disposed in the muffler body;
a first chamber defined between the muffler body and the first plate;
a second chamber defined between the first plate, the second plate and the muffler body;
a third chamber defined between the muffler body and the second plate, the second chamber being disposed between the first and third chambers;
a first pipe having an inlet disposed outside the muffler body and an outlet communicating with the first chamber,
the first pipe extending through the muffler body and the first plate,
the first pipe having at least a portion disposed in the second chamber;
a second pipe having an inlet communicating with the first chamber and an outlet communicating with the third chamber,
the second pipe extending through the first plate, the second chamber and the second plate; and
a third pipe having an inlet communicating with the third chamber and an outlet disposed outside the muffler body,
the third pipe extending through the second plate and the muffler body,
the third pipe having at least a portion disposed in the second chamber;
at least two of the first pipe, the second pipe and the third pipe defining at least one aperture disposed in and fluidly communicating with the second chamber.

11. The muffler of claim 10, wherein:
the first pipe extends through the muffler body, the second plate, the second chamber and the first plate; and
the third pipe extends through the second plate, the second chamber, the first plate and the muffler body.

12. The muffler of claim 11, wherein each of the first pipe, the second pipe and the third pipe defines at least one aperture disposed in and fluidly communicating with the second chamber.

13. The muffler of claim 12, further comprising:
a first mesh disposed in the second chamber around the first pipe;
a second mesh disposed in the second chamber around the second pipe;
a first sound absorbing material disposed between the first mesh and the first pipe;
a second sound absorbing material disposed between the second mesh and the second pipe; and
a third sound absorbing material disposed in the second chamber around the third pipe.

14. The muffler of claim 10, further comprising at least one aperture defined in one of:
the first plate for fluidly communicating the first chamber with the second chamber; and
the second plate for fluidly communicating the third chamber with the second chamber.

15. A vehicle comprising:
an internal combustion engine having at least one exhaust port; and
a muffler fluidly communicating with the at least one exhaust port, the muffler comprising:
a muffler body;
a first chamber defined in the muffler body and fluidly communicating with the at least one exhaust port;
a second chamber disposed at least in part in the first chamber, the second chamber having an inlet, an outlet, and at least one side wall, the at least one side wall defining at least one aperture, the at least one aperture fluidly communicating with the first chamber; and
a third chamber disposed at least in part in the first chamber, the third chamber having an inlet, an outlet, and at least one side wall, the at least one side wall defining at least one aperture, the at least one aperture fluidly communicating with the first chamber,
the outlet of one of the second and third chambers fluidly communicating with the first chamber.

16. The vehicle of claim 15, wherein the muffler further comprises:
a fourth chamber adjacent the first chamber; and
a plate separating the first chamber from the fourth chamber, the plate defining at least one aperture fluidly communicating the fourth chamber with the first chamber;
wherein the outlet of the one of the second and third chambers fluidly communicates with the first chamber via the fourth chamber and the at least one aperture defined in the plate.

17. The vehicle of claim 15, wherein the muffler further comprises:
at least one mesh surrounding the at least one side wall of at least one of the second and third chambers; and
sound absorbing material disposed between the at least one side wall of the at least one of the second and third chambers and a corresponding one of the at least one mesh.

18. The vehicle of claim 15, wherein the muffler further comprises sound absorbing material disposed in the first chamber.

19. The vehicle of claim 15, wherein:
the second chamber is defined by a first pipe;
the third chamber is defined by a second pipe;
the first chamber is defined at least in part by a plate and the muffler body; and
the first and second pipes extend through the plate.

20. The vehicle of claim 15, further comprising:
a frame supporting the engine, the frame including a tunnel;
at least one ski operatively connected to the frame; and
a drive track driven by the engine and disposed in part inside the tunnel.
